(19) United States
(12) Patent Application Publication
(10) Pub. No.: US 2013/0244730 A1
(43) Pub. Date: Sep. 19, 2013

(54) USER TERMINAL CAPABLE OF SHARING IMAGE AND METHOD FOR CONTROLLING THE SAME

(71) Applicant: INDUSTRY-UNIVERSITY COOPERATION FOUNDATION HANYANG UNIVERSITY, Seoul (KR)

(72) Inventor: Chang-sik YOO, Seoul (KR)

(73) Assignee: INDUSTRY-UNIVERSITY COOPERATION FOUNDATION HANYANG UNIVERSITY, Seoul (KR)

(21) Appl. No.: 13/785,266

(22) Filed: Mar. 5, 2013

(30) Foreign Application Priority Data
Mar. 6, 2012 (KR) 10-2012-0022984
Mar. 6, 2012 (KR) 10-2012-0022986
Mar. 6, 2012 (KR) 10-2012-0022988
Mar. 6, 2012 (KR) 10-2012-0023012
Mar. 8, 2012 (KR) 10-2012-0024073
Mar. 8, 2012 (KR) 10-2012-0024092
Mar. 30, 2012 (KR) 10-2012-0032982
Mar. 30, 2012 (KR) 10-2012-0033047
Apr. 25, 2012 (KR) 10-2012-0043148
May 31, 2012 (KR) 10-2012-0057996
May 31, 2012 (KR) 10-2012-0057998
May 31, 2012 (KR) 10-2012-0058000
Feb. 26, 2013 (KR) 10-2013-0020747

(51) Int. Cl. H04M 1/23

(52) U.S. Cl. CPC H04M 1/23
USPC 455/566

(57) ABSTRACT

A user terminal capable of sharing images and a method for controlling the user terminal are disclosed. The user terminal can include: a position image generation unit configured to generate a position image corresponding to a position of a touch means when the touch means is touching a display unit or is near the display unit; and a sensing unit configured to sense at least one of a touch pressure and a touch area of the touch means, where the position image is changed according to at least one of the touch pressure and the touch area of the touch means sensed by the sensing unit. Certain embodiments of the invention provide the advantages of enabling a user terminal and a different type of terminal to share images and minimizing touch errors on a touch interface.

### CROSS-REFERENCE TO RELATED APPLICATIONS

This application claims the benefit of Korean Patent Applications Nos. 10-2012-0023012 (filed on Mar. 6, 2012), 10-2012-0022986 (filed on Mar. 6, 2012), 10-2012-0022988 (filed on Mar. 6, 2012), 10-2012-0022984 (filed on Mar. 6, 2012), 10-2012-0024073 (filed on Mar. 8, 2012), 10-2012-0024092 (filed on Mar. 8, 2012), 10-2012-0032982 (filed on Mar. 30, 2012), 10-2012-0033047 (filed on Mar. 30, 2012), 10-2012-0043148 (filed on Apr. 25, 2012), 10-2012-0057996 (filed on May 31, 2012), 10-2012-0057998 (filed on May 31, 2012), and 10-2012-0058000 (filed on May 31, 2012) filed with the Korean Intellectual Property Office. The disclosures of the above applications are incorporated herein by reference in their entirety.

### BACKGROUND

1. Technical Field

The present invention relates to a user terminal, more particularly to a user terminal capable of sharing images and a method for controlling the user terminal.

2. Description of the Related Art

The use of smart phones is steadily increasing, and for many people, the smart phone has become a personal device that is essential for everyday living. The smart phone provides numerous uses in addition to voice calls, such as gaming, information search, managing personal information, and the like. Moreover, the utility of the smart phone is continuously expanding, as various new applications are being developed.

With advances in CPU and memory device technology, the smart phone provides the functions of a miniature computer, but due to the constraint in the size of its display, there is a limit in utilizing the various application programs available.

For example, certain games may require play on a large screen, but because of the constraint in display size, it may be difficult to play such games on a smart phone.

Also, as most smart phones employ a touch-based interface, the executing objects forming the interface may have to be positioned close to one another in a tight arrangement, and the tight arrangement of these interface-executing objects would often result in touch input errors.

### SUMMARY

An aspect of the invention is to propose a user terminal and a recorded medium that enable the sharing of images with a type of terminal different from the type of the user terminal.

Another aspect of the invention is to propose a user terminal and a recorded medium that can minimize erroneous touch inputs for a touch interface.

To achieve the objectives above, an embodiment of the invention provides a user terminal that includes: a position image generation unit configured to generate a position image corresponding to a position of a touch means when the touch means is touching a display unit or is near the display unit; and a sensing unit configured to sense at least one of a touch pressure and a touch area of the touch means, where the position image is changed according to at least one of the touch pressure and the touch area of the touch means sensed by the sensing unit.

The position image may not be shown if at least one of the touch pressure and the touch area is within a particular level range.

The position image may be changed in form according to at least one of the touch pressure and the touch area of the touch means.

The user terminal can further include an information provider unit configured to output information indicating at least one of the touch pressure and the touch area of the touch means.

The user terminal can further include a setting unit configured to activate or deactivate the operation of sensing at least one of the touch pressure and the touch area of the sensing unit.

Another aspect of the invention provides a user terminal that includes: a display unit; and a position image generation unit configured to generate a position image corresponding to a position of a touch means when the touch means is touching a display unit or is near the display unit, where the position image is changed in form if the position image is shown over a preset event-executing object.

Still another aspect of the invention provides a user terminal that includes: a display unit; and a position image generation unit configured to generate a position image corresponding to a position of a touch means when the touch means is touching a display unit or is near the display unit, where the position image is changed in form if the position image is shown at a preset position.

Another aspect of the invention provides a method for controlling a user terminal that includes: (a) sensing at least one of a touch pressure and a touch area of a touch means when the touch means touches a display unit; and (b) generating a position image corresponding to a position of the touch means if the touch means is touching the display unit or is near the display unit, where the position image is changed according to at least one of the touch pressure and the touch area of the touch means sensed in said step (a).

Yet another aspect of the invention provides a method for controlling a user terminal that includes: (a) sensing a touching or a bringing near of a touch means with respect to a display unit; and (b) generating a position image corresponding to a position of the touch means if it is sensed in said step (a) that the touch means is touching or is near, where the position image is changed in form if the position image is shown over a preset event-executing object.

Another aspect of the invention provides a method for controlling a user terminal that includes: (a) sensing a touching or a bringing near of a touch means with respect to a display unit; and (b) generating a position image corresponding to a position of the touch means if it is sensed in said step (a) that the touch means is touching or is near, where the position image is changed in form if the position image is shown at a preset position.

Yet another aspect of the invention provides a recorded medium on which a program of instructions for executing the methods described above is recorded.

Certain embodiments of the invention provide the advantage of enabling a user terminal and a different type of terminal to share images.

Also, certain embodiments of the invention provide the advantage of minimizing touch errors on a touch interface.

### BRIEF DESCRIPTION OF THE DRAWINGS

FIG. 1 schematically illustrates the composition of a system for sharing an image between terminals according to an embodiment of the invention.

FIG. 2 is a flowchart illustrating the operations for sharing an image between a user terminal and a receiving terminal according to an embodiment of the invention.

FIG. 3 is a flowchart illustrating the operations for sharing an image between a user terminal and a receiving terminal according to another embodiment of the invention.

FIG. 4 illustrates an example of a position image of touch means according to an embodiment of the invention.

FIG. 5 illustrates an example of a change in the position image according to an embodiment of the invention.

FIG. 6 illustrates an example of a change in the position image according to touch level, according to an embodiment of the invention.

FIG. 7 is a flowchart illustrating the process for exchanging image information between a user terminal 100 and a receiving terminal 102 according to an embodiment of the invention.

FIG. 8 is a flowchart illustrating the process for exchanging image information between a user terminal 100 and a receiving terminal 102 according to another embodiment of the invention.

FIG. 9 is a flowchart illustrating the process for exchanging image information between a user terminal 100 and a receiving terminal 102 according to still another embodiment of the invention.

FIG. 10 is a block diagram illustrating the modular composition of a user terminal according to an embodiment of the invention.

FIG. 11 is a block diagram illustrating the modular composition of a user terminal according to another embodiment of the invention.

FIG. 12 is a block diagram illustrating the modular composition of a user terminal according to still another embodiment of the invention.

### DETAILED DESCRIPTION

Certain embodiments of the invention will be described below in more detail with reference to the accompanying drawings.

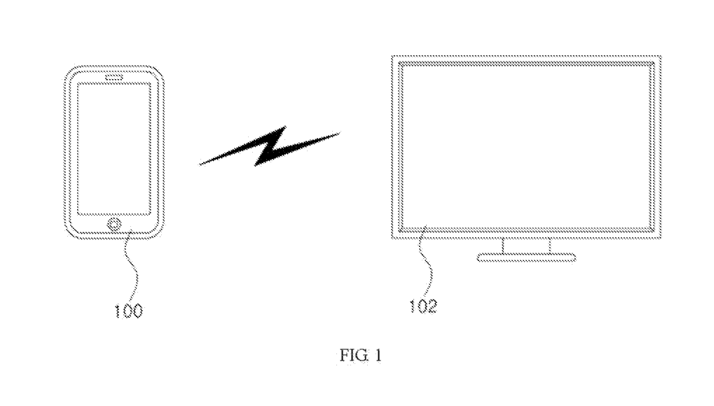

FIG. 1 schematically illustrates the composition of a system for sharing an image between terminals according to an embodiment of the invention.

Referring to FIG. 1, a system for sharing an image between terminals according to an embodiment of the invention may include a user terminal 100 and a receiving terminal 102.

The user terminal 100 may be the terminal which provides an image, and may be a terminal that is capable of running application programs, is capable of communicating with other terminals, and is equipped with a display unit, such as a smart phone, a laptop, and a netbook, for example. Preferably, the user terminal 100 can be a terminal that provides a touch interface.

The receiving terminal 102 may be the terminal which is not directly manipulated by the user but which shares the image shown on the display unit of the user terminal 100. Preferably, the receiving terminal 102 can be a terminal having a display unit that is relatively larger than the user terminal 100, and examples of the receiving terminal 102 can include devices such as a TV, a monitor, etc.

The user terminal 100 and the receiving terminal 102 may be equipped with communication modules that can communicate with each other to share images. The user terminal 100 and the receiving terminal 102 can communicate by various methods; for example, the user terminal 100 and the receiving terminal 102 can communicate using Wi-Fi. In another example, the user terminal 100 and the receiving terminal 102 could also communicate using a near-field communication method such as Bluetooth and NFC. In still another example, the user terminal 100 and the receiving terminal 102 could also communicate by a wireless HDMI method. The skilled person would appreciate that, if at least one of the user terminal 100 and the receiving terminal 102 is not equipped with a built-in communication module, the communication can also be performed using an external device that is capable of interworking with the user terminal 100 or the receiving terminal 102.

Also, the user terminal 100 and receiving terminal 102 could also communicate via a communication device such as a server.

Primarily, according to an embodiment of the invention, the image shown on the display unit of the user terminal 100 may be shared on the display unit of the receiving terminal 102. To this end, the user terminal 100 may use a communication module to transmit to the receiving terminal 102 the image information shown on the display unit of the user terminal 100. The communication module of the receiving terminal 102 may use the image information transmitted from the user terminal 100 to display the same image on the display unit of the receiving terminal as the image on the user terminal 100. By virtue of this primary function, the image provided by the user terminal 100 can be viewed by the user through the display unit of another device, rather than the display unit of the user terminal 100.

For example, if a video clip is being played on the user terminal 100, the information on the corresponding video clip can be transmitted to the receiving terminal 102, to allow viewing of the corresponding video clip through the display unit of the receiving terminal 102. If the user wishes to view the video clip on a screen that is larger compared to the display unit of the user terminal 100, it is possible to utilize a device such as a TV as the receiving terminal 102, to view the video clip through the TV.

Secondarily, according to an embodiment of the invention, not only the image shown on the display unit of the user terminal 100 but also the position information of a touch means that touches or is near the display unit of the user terminal 100 may be shared between the user terminal 100 and the receiving terminal 102. When a touch means is brought near to or is performing a touch operation on the display unit of the user terminal 100, the information regarding which area the touch means is positioned in may be shared between the user terminal 100 and the receiving terminal 102. Using the position information of the touch means thus shared, the receiving terminal 102 may show the image (hereinafter referred to as the “position image”) at a point corresponding to the position of the touch means. Here, the touch means can include any type of means that can perform a touch operation to control the terminal, such as a touch pen and a finger.

The position image can take any of a variety of forms, such as a mouse pointer shaped as an arrow, a circular shaded image, etc. The position image will be described below in further detail.

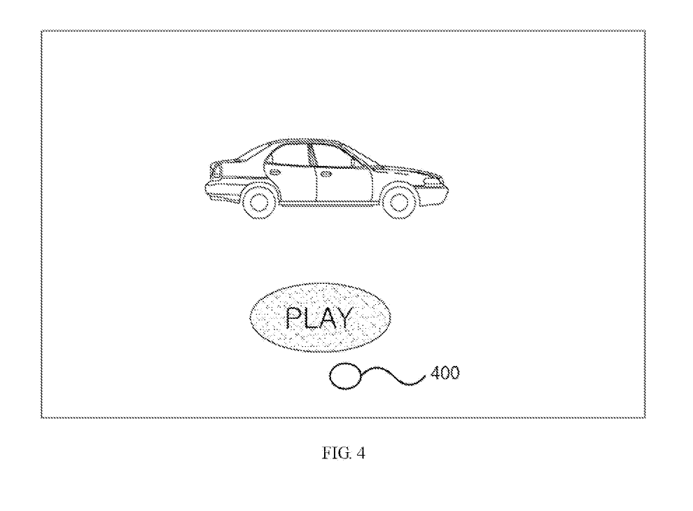

FIG. 4 illustrates an example of a position image of touch means according to an embodiment of the invention.

Referring to FIG. 4, a position image 400 is shown in the form of a circular shading, at a point corresponding to the position of a touch means that is near or is touching the display unit of the user terminal 100.

The function of sharing the position information of the touch means enables the user to manipulate the user terminal 100 while looking at the receiving terminal 102 and not the user terminal 100. For example, if the user is using a web browser for web surfing, the user can identify the position of the touch means while looking only at the receiving terminal 102, and can use the position image to select a desired item from a web document while looking at the receiving terminal 102.

Various manipulations can be made using the position image, in addition to the manipulation for selecting a particular item from a web document.

As another example, it is also possible, by using the position image, to manipulate a game running on the user terminal 100 while looking at the receiving terminal 102. The example in FIG. 4 shows the screen of a racing game, where the user can select a particular menu in the game or manipulate a character by using the position image.

The function by which the image shown on the display unit of the user terminal 100 and the position image of the touch means are shown on the receiving terminal 102, according to an embodiment of the invention, can be useful when the user wishes to utilize the display unit of another terminal instead of the display unit of the user terminal 100.

When the user wishes to play a game on a larger screen, a device equipped with a display unit of a relatively larger size, such as a TV or a monitor, can be set as the receiving terminal, to enable game play using the screen of the TV or monitor. The skilled person would appreciate that the function provided by an embodiment of the invention can be utilized for various purposes other than gaming.

The position image, which may indicate the position information of a touch means that is near or in contact with the display unit of the user terminal 100, can also be shown on the user terminal 100 as well as the receiving terminal 102. In particular, the position image that indicates the position information of a touch means near the user terminal's display unit can be useful in minimizing erroneous touch operations.

According to an embodiment of the invention, the form of the position image of a touch means can be changed according to its position.

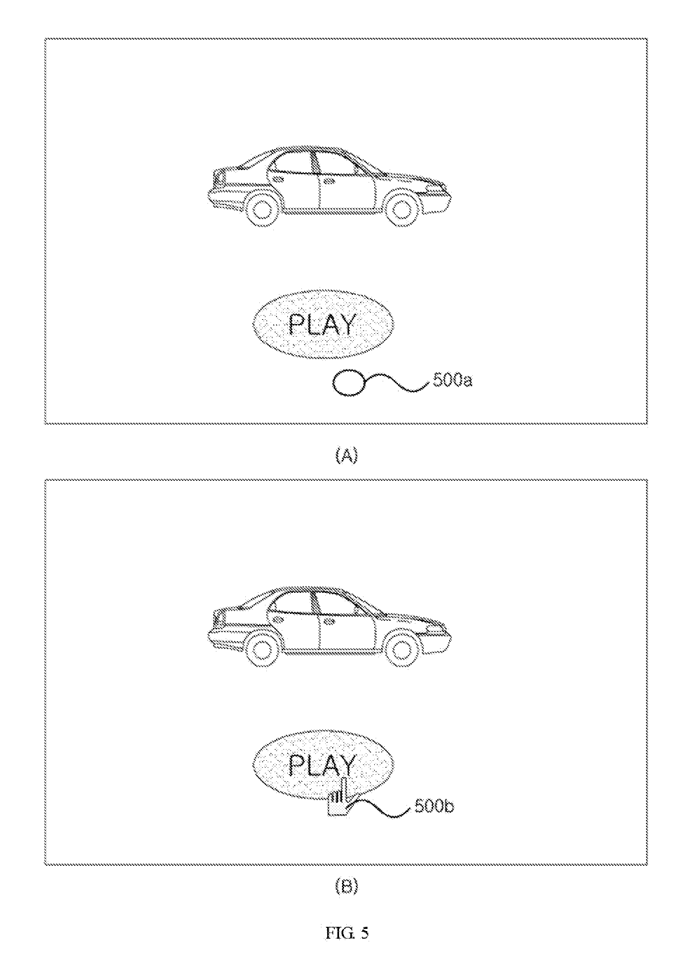

For example, the position image can be shown in a different form if it is positioned over a displayed event-executing object for a content. FIG. 5 illustrates an example of a change in the position image according to an embodiment of the invention.

When the position image is not positioned over an event-executing object, it may be shown as a circular image 500a as illustrated in drawing (A) of FIG. 5, but when the position image is positioned over the “PLAY” button, which is an event-executing object for executing a game, the position image can be changed from the previous circular form to a finger-shaped image 500b as illustrated in drawing (B) of FIG. 5.

From the change in the position image, the user can recognize that the point that currently is about to be touched or is touched is a point at which a particular control command can be executed by a touch.

Of course, the skilled person would appreciate that the form of the position image can be changed under various conditions other than when the position image is over an event-executing object, and by way of the changed position image, the user can be provided with additional information.

The form of the position image can be changed not only according to the position of the position image but also according to the movement of the touch means. After the position of the touch means is shown as the position image on the display unit of the user terminal 100 or the receiving terminal 102, when the user changes the position of the touch means while maintaining a state of nearness or contact, a change can be implemented, such as by having the position image changed from a shaded image to a finger image.

The image processing for the change in form of the position image may preferably be implemented at the user terminal 100. However, the image processing for changing the form of the position image can also be implemented at the receiving terminal 102 as necessary.

The option of whether or not a position image is to be shown on the user terminal 100 can be selected by the user through a separate setting unit. The user terminal 100 can provide an interface regarding whether or not to show a position image on the user terminal, and this interface may allow an on/off setting with respect to showing the position image at the user terminal.

The above descriptions of the position image according to certain embodiments of the invention are provided as examples. The skilled person would appreciate that numerous variations are possible for the change in form, etc., of the position image, and the scope of the invention must not be limited to the examples presented above.

A description is provided below of the basic operations performed for sharing an image between a user terminal 100 and a receiving terminal 102 according to an embodiment of the invention.

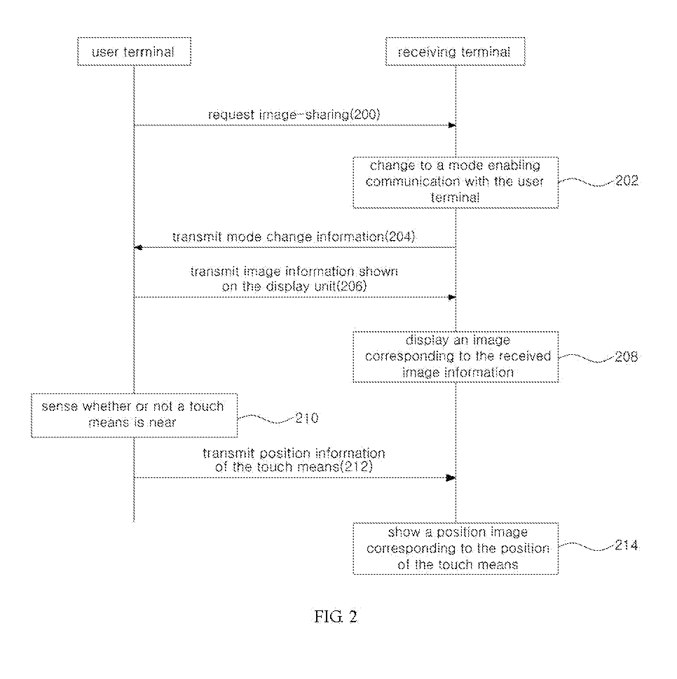

FIG. 2 is a flowchart illustrating the operations for sharing an image between a user terminal and a receiving terminal according to an embodiment of the invention.

Referring to FIG. 2, the user terminal 100 may first send a request for image-sharing to the receiving terminal 102 (step 200).

The receiving terminal 102, on receiving the request for image-sharing from the user terminal 100, may change to a mode that enables communication with the user terminal 100 (step 202) and may transmit information to the user terminal 100 indicating that the mode change for image-sharing is complete (step 204).

The user terminal 100 may transmit the image information shown on the display unit to the receiving terminal 102 (step 206), and the receiving terminal 102 may display an image corresponding to the received image information on its own display unit (step 208).

The user terminal 100 may sense whether or not a touch means is near (step 210). If a touch means is near, the position information of the nearby touch means may be transmitted to the receiving terminal 102 (step 212). Here, the position information of the touch means that is nearby can be transmitted to the receiving terminal in various ways.

According to an embodiment of the invention, if a position image is to be shown on the user terminal 100, the image shown on the display unit of the user terminal 100 with the position image incorporated can itself serve as the position information of the touch means. Since the position image is shown on the user terminal 100, it is possible to provide the position information of the touch means by transmitting the image itself that is shown on the display unit.

The position image shown on the user terminal 100 can be useful in preventing touch errors beforehand when a blunt touch means, such as a finger, is used. According to another embodiment of the invention, the position information of the touch means can include coordinate information and form information of the position image. The user terminal 100 can output the coordinate information and form information of the position image and provide them to the receiving terminal 102. Here, the coordinate information of the position image can include the pixel coordinates at which the position image is to be shown in the image displayed on the display unit of the user terminal 100. Of course, the coordinate information of the position image can be provided in various ways other than by using pixel coordinates.

According to still another embodiment of the invention, if no particular position image is to be shown on the user terminal 100, a position image can be synthesized into the image currently shown on the display unit to generate a separate image incorporating the position image, and the synthesized image thus generated can correspond to the position information of the touch means.

When the position information of the touch means is received from the user terminal 100, the receiving terminal may show a position image corresponding to the position of the touch means (step 214). Upon receiving information on the image itself shown on the display unit of the user terminal that includes a position image or the image with the position image synthesized therein from the user terminal, the receiving terminal 102 can display the corresponding image and thereby show the position image. If the coordinate and form information of the position image is provided separately from the user terminal 100, the receiving terminal 102 may generate and show the position image at the corresponding coordinate position.

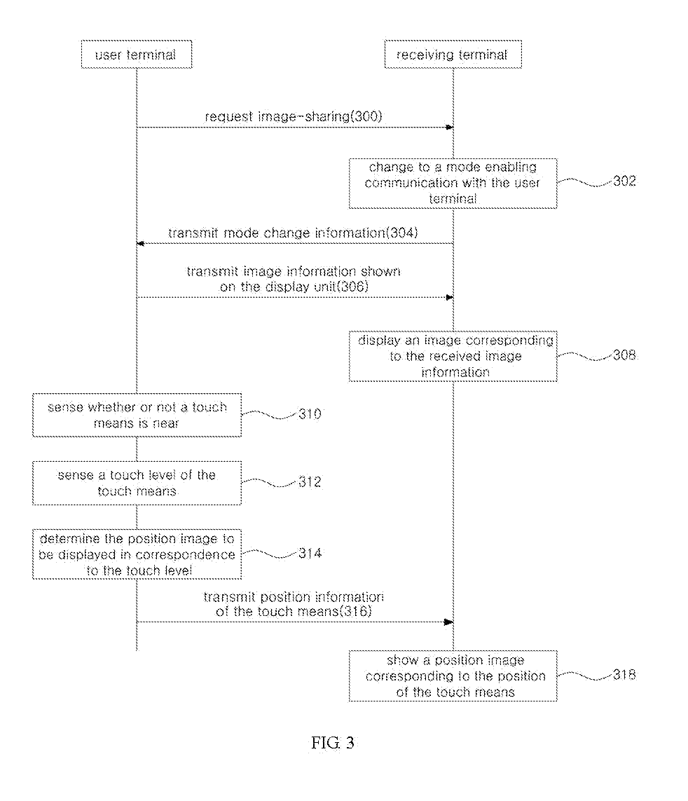

FIG. 3 is a flowchart illustrating the operations for sharing an image between a user terminal and a receiving terminal according to another embodiment of the invention.

Unlike the embodiment illustrated in FIG. 2, the embodiment in FIG. 3 relates to an example of showing a position image if the touch means directly touches the display unit of the user terminal 100.

In FIG. 3, the operations other than that for sensing the touch means are substantially the same as those described with reference to FIG. 2, and as such, only the portions related to the sensing operation will be described here.

The user terminal 100 may sense whether or not a touch means is touching the display unit of the user terminal 100 (step 310). If the touch of a touch means is sensed, the touch level of the touch means may be sensed (step 312). Here, a touch level may refer to at least one of a touch pressure and a touch area of the touch means.

When the touch level of the touch means is sensed, the position image that is to be displayed may be determined in correspondence to the sensed touch level (step 314).

According to an embodiment of the invention, if at least one of the sensed touch pressure and touch area belongs to a preset first level class, then a position image may not be shown even if a touch is sensed, and if at least one of the sensed touch pressure and touch area belongs to a preset second level class, then a position image may be shown that corresponds to the touch point.

For example, if at least one of the touch pressure and the touch area is greater than or equal to a preset threshold, a position image may not be shown even though a touch is sensed, and if it is below a preset threshold, a position image may be shown that corresponds to the touch point.

Of course, the touch level classes for changing the position image can be divided further, and the position image can be changed for each of the touch level classes. For instance, the size of the position image can be adjusted in proportion to or in inverse proportion to the sensitivity of the touch level.

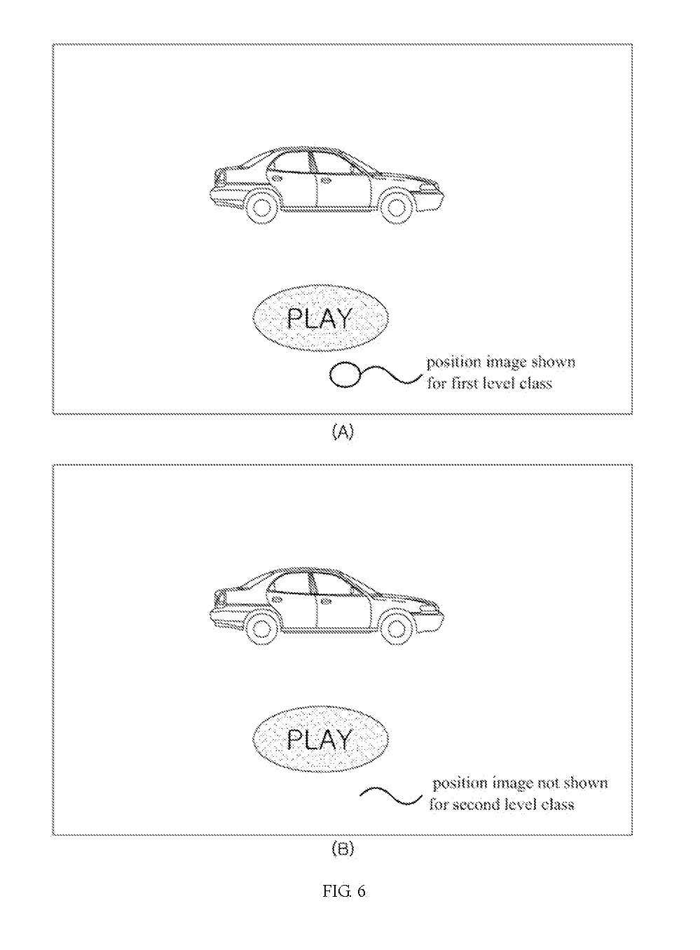

FIG. 6 illustrates an example of a change in the position image according to touch level, according to an embodiment of the invention.

Referring to FIG. 6, drawing (A) illustrates a screen shown on the receiving terminal when the touch level (touch pressure or touch area) belongs to a first level class, while drawing (B) illustrates a screen shown on the receiving terminal when the touch level belongs to a second level class that is higher than the first level class. Obviously, the same screen can be shown on the user terminal as well according to the user's selection.

When the user touches the display unit of the user terminal with a relatively lighter touch pressure (corresponding to the first level class), the position image can be shown as in drawing (A).

However, when the user increases the touch pressure and touches the display unit of the user terminal with a pressure corresponding to the second level class, the position image may not be shown, as is the case in drawing (B).

The above descriptions relating to changes in the position image according to touch level are for illustrative purposes, and the skilled person would appreciate that numerous variations are possible other than the embodiments illustrated above.

A description is provided below in further detail regarding a method of sensing a nearness or a touch operation of a touch means.

According to an embodiment of the invention, the nearness of a touch means can be sensed using capacitance. In this case, a capacitive type touch panel may be used, and if the user brings a touch means, such as a finger or a touch pen, near the touch panel, it is possible to sense the change in capacitance and thus sense the position of the nearby touch means.

According to another embodiment of the invention, an ultrasonic method can be used. For example, a touch unit on a touch pen may emit infrared rays and ultrasonic waves, which may be received by a receiver equipped with an infrared sensor and two ultrasonic sensors to sense the movement and position information of the touch pen.

Looking at the method by which the receiver may detect the position of the touch pen, the three sensors may respectively measure the transmission time of the infrared rays and the transmission time of the ultrasonic waves, convert the transmission times into distances, and then detect the position of the touch pen using the converted distances by a method such as triangulation, etc.

According to still another embodiment of the invention, electromagnetic induction can be used to sense a nearness of a touch pen or a touch operation of a touch pen. When a touch pen having a metal coil is brought near the touch panel, electromagnetic induction may occur between the touch pen and the touch panel, and it is possible to sense whether or not the touch pen is near by way of the alteration in the electromagnetic field caused by this electromagnetic induction.

Of course, the skilled person would appreciate that various sensing methods other than those described above can also be employed, such as methods using a resistive film, optical methods, etc.

A description is provided below in further detail regarding a method of exchanging image information between a user terminal 100 and a receiving terminal 102.

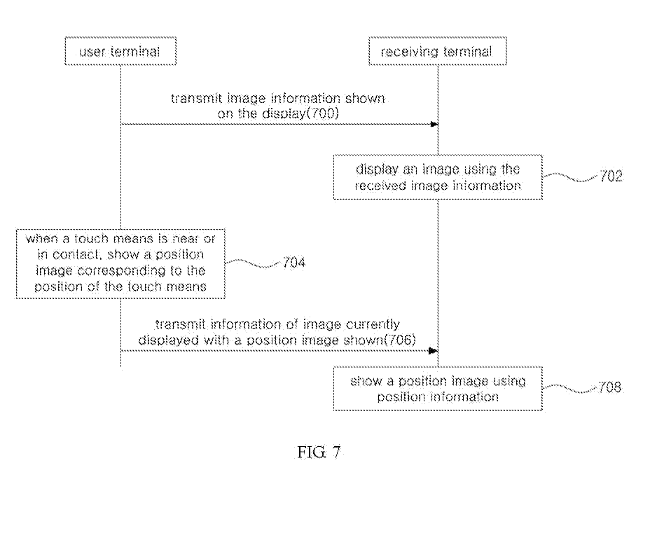

FIG. 7 is a flowchart illustrating the process for exchanging image information between a user terminal 100 and a receiving terminal 102 according to an embodiment of the invention.

Referring to FIG. 7, the user terminal 100 may transmit the image information shown on the display unit to the receiving terminal 102 (step 700).

Using the image information received from the user terminal 100, the receiving terminal 102 may display an image on its display unit (step 702). The user terminal 100 can transmit or receive image information by way of an HDMI (High-Definition Multimedia Interface) method, for instance. Various methods for exchanging multimedia data other than HDMI can also be used.

When the user brings a touch means near to or in contact with the display unit of the user terminal 100, the user terminal 100 may show a position image in correspondence to the position of the touch means (step 704).

The position image can be shown as an overlay, or the position image of a preset form can be synthesized with the image shown on the display unit.

The user terminal 100 may transmit information to the receiving terminal 102 regarding the current display image in which the position image is shown (step 706). As described above, the position image can be shown on the display unit of the user terminal 100 as an overlay or can be shown on the display unit of the user terminal 100 by image synthesis. The user terminal 100 may transmit the display image currently shown after encoding it into a preset format.

The receiving terminal 102 may receive the current display image information of the user terminal 100 from the user terminal 100 and may display an image incorporating the position image (step 708).

If the image information is exchanged according to the embodiment illustrated in FIG. 7, the user terminal 100 and the receiving terminal 102 may always display the same image on their respective displays.

FIG. 8 is a flowchart illustrating the process for exchanging image information between a user terminal 100 and a receiving terminal 102 according to another embodiment of the invention.

Referring to FIG. 8, the user terminal 100 may transmit the image information shown on the display unit to the receiving terminal 102 (step 800).

Using the image information received from the user terminal 100, the receiving terminal 102 may display an image on its display unit (step 802).

When the user brings a touch means near to or in contact with the display unit of the user terminal 100, the user terminal 100 may sense the contact or nearness of the touch means (step 804).

When a touch or a nearness of the touch means is sensed, the user terminal may calculate the position information of the touch means of which the touch or nearness is sensed (step 806). The position information of the touch means can be calculated by various methods.

For instance, the position information of the touch means can be set as the coordinates of the touch means which represent the relative position of the touch means when the display unit of the user terminal 100 is set as the entire coordinate range.

In another example, the coordinates of the touch means can also be set by using the pixel coordinates of the image currently shown on the user terminal's display unit. For example, when the position of the touch means corresponds to a particular pixel of the currently-shown image, the coordinates of the corresponding pixel can be set as the coordinates of the touch means.

Of course, the skilled person would appreciate that the coordinates of the touch means can be calculated by various methods other than those described above.

When the position information of the touch means is calculated, the user terminal may transmit the position information of the touch means to the receiving terminal 102 (step 808).

For instance, when the image information shown on the user terminal is transmitted, the position information of the touch means can be provided as header information for the corresponding image information.

In another example, the position information of the touch means can also be transmitted to the receiving terminal 102 through a separate data channel. In cases where the position information of the touch means is transmitted through a data channel, the user terminal 100 and the receiving terminal 102 may have to establish two channels, i.e. an image channel (a channel for transmitting image data) and a control channel (a channel for transmitting position information), when establishing connection.

Upon receiving the position information of the touch means from the user terminal 100, the receiving terminal 102 may use the position information of the touch means to show a position image on the display unit of the receiving terminal 102 (step 810).

Although it is not illustrated in FIG. 8, the receiving terminal 102 can receive not only the position information of the position image but also the form information of the position image. As described above, the position image can change in size or form according to its position, and such form information of the position image can also be provided through the user terminal. As in an example described above, if the position image is positioned over a particular event-executing object, a position image having a different form from that of a regular position image can be provided, and such changed form information can also be provided together with the position information of the touch means.

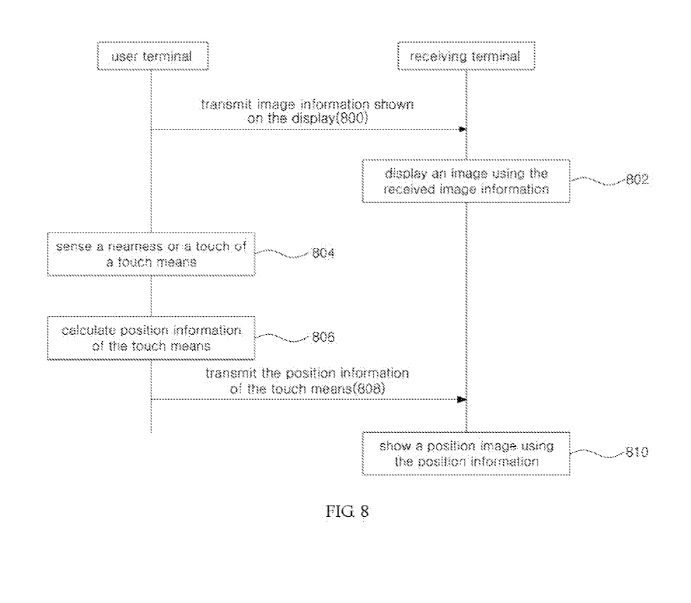

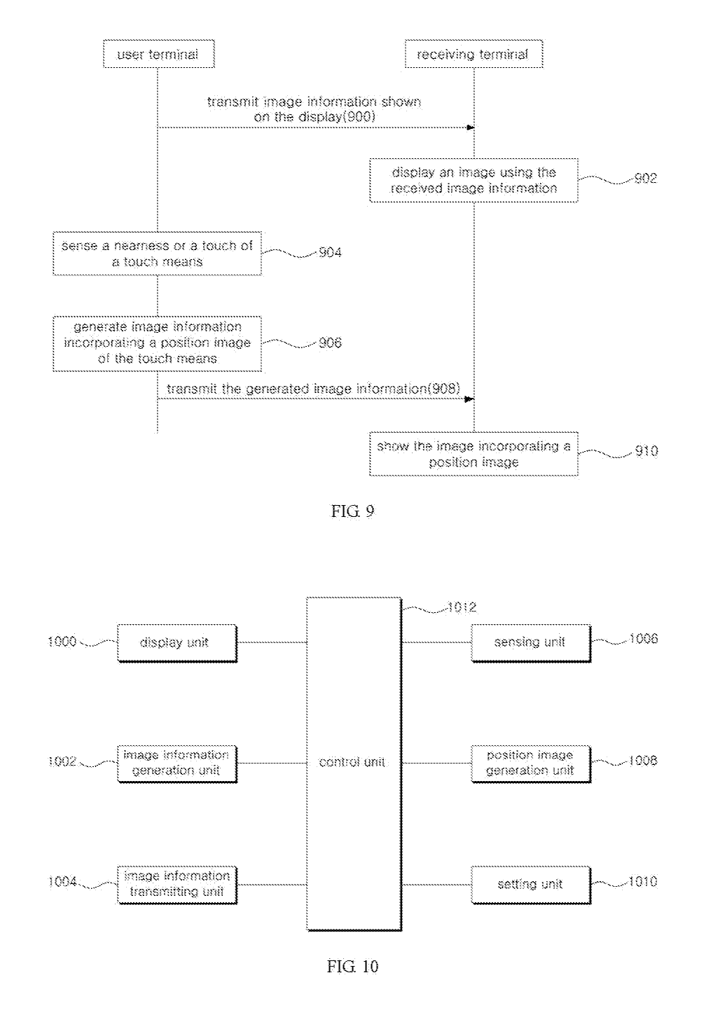

FIG. 9 is a flowchart illustrating the process for exchanging image information between a user terminal 100 and a receiving terminal 102 according to still another embodiment of the invention.

Referring to FIG. 9, the user terminal 100 may transmit the image information shown on the display unit to the receiving terminal 102 (step 900).

Using the image information received from the user terminal 100, the receiving terminal 102 may display an image on its display unit (step 902).

When the user brings a touch means near to or in contact with the display unit of the user terminal 100, the user terminal 100 may sense the contact or nearness of the touch means (step 904).

When a touch or a nearness of the touch means is sensed, the position of the touch means may be identified, and image information may be generated that incorporates a position image for the identified touch means (step 906). The image information thus generated may preferably be image information that is encoded in a predetermined format agreed upon with the receiving terminal.

The image information generated to incorporate a position image may be displayed on the user terminal or may not be shown on the display of the user terminal.

The user terminal 100 may transmit the image information, generated to incorporate a position image, to the receiving terminal 102 (step 908).

The receiving terminal 102 may use the received image information to display an image incorporating a position image on its display (step 910).

Certain methods for providing information regarding the position image to the receiving terminal have been described above. The embodiments described above are for illustrative purposes, and the skilled person would appreciate that the information relating to the position image can be provided by using various communication methods other than those of the illustrative embodiments described above.

A description is provided below of the detailed modular composition of a user terminal to which an embodiment of the invention may be applied. The user terminal to which an embodiment of the invention is applied can operate according to the following descriptions after a particular application is installed, or the firmware for executing the operations described below can be installed at the time of the terminal's manufacture.

FIG. 10 is a block diagram illustrating the modular composition of a user terminal according to an embodiment of the invention.

Referring to FIG. 10, a user terminal according to an embodiment of the invention can include a display unit 1000, an image information generation unit 1002, an image information transmitting unit 1004, a sensing unit 1006, a position image generation unit 1008, a setting unit 1010, and a control unit 1012.

The display unit 1000 may display an image according to the operation of the user terminal 100. The display unit 1000 may display images using various apparatuses such as LCD or LED, and may provide a touch interface. The display unit may display various screens according to the operation of the terminal such as a user interface screen, an application execution screen, etc.

The image information generation unit 1002 may generate information regarding the image displayed on the display unit 1000. The image information generation unit 1002 may generate image information that is encoded in a preset format, for which various known encoding methods can be used.

The image information transmitting unit 1004 may transmit the image information generated by the image information generation unit 1002 to the receiving terminal 102. As described above, the transmission of image information can be implemented by various communication methods such as Wi-Fi, wireless HDMI, etc. The image information transmitting unit 1004 may also serve to transmit information regarding the position image.

The sensing unit 1006 may serve to sense a touch means such as a finger or a touch pen, etc. The sensing unit 1006 may sense whether or not a touch means is brought near the display unit 1000 and whether or not a touch is made on the display unit 1000.

According to a preferred embodiment of the invention, the sensing unit 1006 may sense a touch state of a touch means, more specifically, at least one of a touch pressure and a touch area. As described above, levels can be set beforehand for the touch pressure and touch area, and the sensing unit 1006 may sense the level which at least one of the touch pressure and touch area correspond to. For instance, a first level class corresponding to a low pressure and a second level class corresponding to a high pressure can be set, and the sensing unit can sense which level class, between the first level class and the second level class, a touch pressure corresponds to.

The user terminal 100 can determine whether or not to execute an action according to a touch operation in correspondence to the touch pressure and touch area sensed by the sensing unit 1006. For example, if at least one of the touch pressure and the touch are belongs to a lower level, then the user terminal 100 may not execute an action according to the touch, and if it belongs to a higher level, an action corresponding to the touch can be performed. That is, even if a touch is made on an event-executing object, a touch operation may be performed only when at least one of the touch pressure or the touch area is greater than or equal to a preset level.

The position image generation unit 1008 may generate a position image corresponding to the position of a touch means if the sensing unit 1006 senses that the touch means is near or making a touch.

As described above, the position image can be generated in various forms, such as a shaded image, a cursor pointer image, etc.

According to an embodiment of the invention, the position image of a preset form can be shown as an overlay on the image currently shown, or the position image can be synthesized with the currently-shown image.

The position image generated by the position image generation unit 1008 can be changed according to the sensing level sensed by the sensing unit 1006.

For instance, if the touch pressure or the touch area is of a lower level, the position image generation unit 1008 may generate and show a position image, and if the touch pressure or the touch area is of a higher level, it may not show the position image.

In another example, if the touch pressure or the touch area is of a lower level, the position image generation unit 1008 may generate a position image having a small size, and if the touch pressure or the touch area is of a higher level, the position image generation unit 1008 may generate a position image having a larger size.

In cases where the user maintains a touch state while moving the touch means, the position image can be an image that shows the touch trajectory, where a thick trajectory can be shown if the touch pressure or touch area is large while a thin trajectory can be shown if the touch pressure or touch area is small.

In still another example, position images having different forms can be provided for the position image when the touch pressure and touch area is of a lower level and when the touch pressure and touch area is of a higher level.

As described above, the position image generated at the position image generation unit 1008 can have different forms depending not only on the sensing level of the sensing unit but also on the position of the position image. For example, the form of the position image when the position image is shown over an event-executing object can be different from the normal form of the position image. The position image can be modified in form in cases other than when it is over an event-executing object if a particular position of the position image is associated with a particular event.

The position image can be shown as an overlay, or a preset position image can be synthesized with the image currently shown.

If the position image itself is shown on the user terminal as in the embodiment illustrated in FIG. 10, the information regarding the position image can be provided as the image information generation unit 1002 generates the image information regarding the image currently shown.

The setting unit 1010 may serve to provide a setting interface for the various functions for sharing the image shown on the display and the position image. For example, it can provide a setting interface for setting the sensing level classes of the sensing unit and the changes in the position image according to sensing levels, and can also serve to store the settings information. To be more specific, the setting unit 1010 can change the settings such that the sensing unit 1006 only senses whether or not a touch is made and the function for sensing the levels of touch pressure and area is deactivated.

The control unit 1012 may serve to control the overall operations of the components described above.

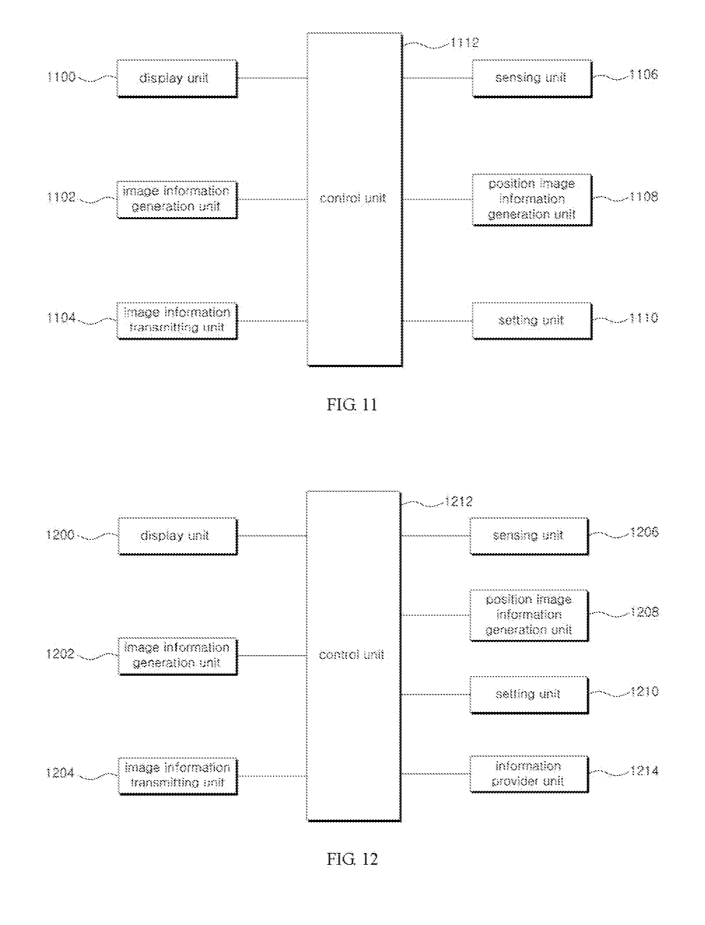

FIG. 11 is a block diagram illustrating the modular composition of a user terminal according to another embodiment of the invention.

Referring to FIG. 11, a user terminal according to another embodiment of the invention can include a display unit 1100, an image information generation unit 1102, an image information transmitting unit 1104, a sensing unit 1106, a position image information generation unit 1108, a setting unit 1110, and a control unit 1112.

In describing FIG. 11, the components that are the same as in the embodiment illustrated in FIG. 10 will not be described again.

FIG. 11 illustrates the modular composition of a user terminal which transmits the information of the position image separately, instead of transmitting the currently shown image of the user terminal incorporating the position image as in FIG. 10.

In the user terminal of FIG. 11, the position image information generation unit 1108 may generate position information and form information of a position image if the sensing unit 1106 senses a touch or a nearness of a touch means. If the form information of the position image is set beforehand in agreement with the receiving terminal 102, it would also be possible to generate only the position information of the position image.

As described above, the position information of the position image can include coordinate information of a touch means that is nearby or in contact, with respect to the currently-shown screen of the user terminal 100, where the corresponding coordinate information can be provided to the receiving terminal 102 by way of the image information transmitting unit 1104. Of course, a separate module can be included which only transmits the position image information.

The position image information can be provided through a different channel from that used for transmitting the information of the image currently shown on the display of the user terminal 100, and if the same channel is used, the position image information can be included in the header of the image information.

FIG. 12 is a block diagram illustrating the modular composition of a user terminal according to still another embodiment of the invention.

Referring to FIG. 12, a user terminal according to still another embodiment of the invention can include a display unit 1200, an image information generation unit 1202, an image information transmitting unit 1204, a sensing unit 1206, a position image generation unit 1208, a setting unit 1210, a control unit 1212, and an information provider unit 1214.

The user terminal illustrated in FIG. 12 additionally includes an information provider unit, compared to the user terminal illustrated in FIG. 10.

The information provider unit 1214 may serve to output a preset type of information in response to a touch of the user or a bringing near of a touch means. For example, the information provider unit 1214 can output information that allows the user to recognize the touch pressure and touch area. To be more specific, the information provider unit 1214 can output information regarding whether the user performs a touch operation with a strong touch pressure or a weak touch pressure, and can output information regarding whether the touch operation is performed with a wide touch area or a narrow touch area.

The information provider unit 1214 can output information in a way that stimulates the user's auditory, tactile, or visual sensations.

If the pressure information or area information is provided in a form that stimulates the user's tactile sensation, the provision of the information can be achieved by using a vibration motor. If a touch is made with a pressure or area smaller than or equal to a preset value, the information provider unit 1214 can inform the user of this fact by way of vibration. If the pressure information or area information is provided in a form that stimulates the user's auditory sensation, the information provider unit can provide the user with such information by way of a speaker. If the pressure information or area information is provided in a form that stimulates the user's visual sensation, the information provider unit can provide the user with such information by way of a light-emitting means on the user terminal 100.

To be more specific, during a movement of a touch means which maintains contact with a touch pressure or a touch area smaller than or equal to a preset value, the information provider unit 1214 can emit a continuous vibration, sound, or light. That is, when the touch of a touch means having a pressure or area smaller than or equal to a preset value is first recognized, a short vibration may be created once (for a first duration), and if the touch means is moved afterwards, a continuous vibration may be created (for a second duration). Here, the second duration can be longer than the first duration.

Also, the information provider unit 1214 can provide position image change information in various forms when the position image is changed in accordance with certain conditions.

The components of the embodiments described above can also be easily understood from the perspective of processes. That is, the components can each be understood as a process.

The embodiments of the present invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

1. A user terminal comprising:
a position image generation unit configured to generate a position image corresponding to a position of a touch means when the touch means is touching a display unit or is near the display unit; and
a sensing unit configured to sense at least one of a touch pressure and a touch area of the touch means,
wherein the position image is changed according to at least one of the touch pressure and the touch area of the touch means sensed by the sensing unit.

2. The user terminal of claim 1, wherein the position image is not shown if at least one of the touch pressure and the touch area is within a particular level range.

3. The user terminal of claim 1, wherein the position image is changed in form according to at least one of the touch pressure and the touch area of the touch means.

4. The user terminal of claim 1, wherein the position image is changed in size according to at least one of the touch pressure and the touch area of the touch means.

5. The user terminal of claim 2, further comprising:
an information provider unit configured to output information indicating at least one of the touch pressure and the touch area of the touch means.

6. The user terminal of claim 1, further comprising:
a setting unit configured to provide an interface for setting sensing level classes of the sensing unit and setting position image changes according to the sensing levels and configured to store settings information.

7. A user terminal comprising:
a display unit; and
a position image generation unit configured to generate a position image corresponding to a position of a touch means when the touch means is touching a display unit or is near the display unit,
wherein the position image is changed in form if the position image is shown over a preset event-executing object.

8. A user terminal comprising:
a display unit; and
a position image generation unit configured to generate a position image corresponding to a position of a touch means when the touch means is touching a display unit or is near the display unit,
wherein the position image is changed in form if the position image is shown at a preset position.

9. The user terminal of claim 7, further comprising: an information provider unit configured to output information according to a change in the position image.

10. A method for controlling a user terminal, the method comprising:
(a) sensing at least one of a touch pressure and a touch area of a touch means when the touch means touches a display unit; and
(b) generating a position image corresponding to a position of the touch means if the touch means is touching the display unit or is near the display unit,
wherein the position image is changed according to at least one of the touch pressure and the touch area of the touch means sensed in said step (a).

11. The method of claim 10, wherein the position image is not shown if at least one of the touch pressure and the touch area is within a particular level range.

12. The method of claim 10, wherein the position image is changed in form according to at least one of the touch pressure and the touch area of the touch means.

13. The method of claim 10, further comprising:
outputting information indicating at least one of the touch pressure and the touch area of the touch means.

14. The method of claim 13, further comprising:
configuring settings to activate or deactivate an operation of sensing at least one of the touch pressure and the touch area of the touch means.

15. A method for controlling a user terminal, the method comprising:
(a) sensing a touching or a bringing near of a touch means with respect to a display unit; and
(b) generating a position image corresponding to a position of the touch means if it is sensed in said step (a) that the touch means is touching or is near,
wherein the position image is changed in form if the position image is shown over a preset event-executing object.

16. A method for controlling a user terminal, the method comprising:
(a) sensing a touching or a bringing near of a touch means with respect to a display unit; and
(b) generating a position image corresponding to a position of the touch means if it is sensed in said step (a) that the touch means is touching or is near,
wherein the position image is changed in form if the position image is shown at a preset position.

17. The method of claim 16, further comprising:
providing information according to a change in the position image.

18. A recorded medium having recorded thereon and tangibly embodying a program of instructions for executing the method for controlling a user terminal according to claim 10.
